(19) United States
(12) Patent Application Publication
(10) Pub. No.: US 2005/0014107 A1
(43) Pub. Date: Jan. 20, 2005

(54) High/low speed suction device and suction tips

(76) Inventor: Janet L. Culver, Concord, NH (US)

Correspondence Address: Bourque & Associates, P.A., Suite 301, 835 Hanover Street, Manchester, NH, 03104, US

(21) Appl. No.: 10/871,178

(22) Filed: Jun. 18, 2004

Related U.S. Application Data
(60) Provisional application No. 60/479,747, filed on Jun. 19, 2003.

(51) Int. Cl. A61C 17/06

(52) U.S. Cl. 433/95

(57) ABSTRACT

A suction device is sized and shaped to easily fit within a user's hand and includes a first region connected to a pump and a second region at an angle, preferably approximately 45 degrees or hingedly connected, to the first region. The second region includes a switch allowing the user to control the suction device without taking the user's hand off the suction device. The suction device preferably includes a tip support that supports at least a portion of a suction tip and is preferably adjustable such that the length of the tip support may be altered. The suction tip also preferably includes a first and a second segment forming a generally V-shape. The first segment connects to the suction device and is preferably rigid. The second segment includes an opening that is preferably oval in shape and preferably generally perpendicular to the second segment.

### CROSS-REFERENCE TO RELATED APPLICATIONS

This application is related to and claims the benefit of Provisional U.S. Patent Application No. 60/479,747 titled “High/Low Speed Suction Device and Suction Tips,” filed by Janet L. Culver on Jun. 19, 2003, and incorporated herein by reference.

### TECHNICAL FIELD

The present invention relates to dentistry and more particularly, relates to suction devices and suction tips for use during dental procedures.

### BACKGROUND

Dentist and dental hygienists commonly use suction devices 10, FIG. 1, to evacuate debris from a patient's mouth during dental procedures. The suction devices 10 typically include two types of devices, a high speed and a slow speed suction device. The known suction devices 10 generally include a body 12 having a first end 14 connected to a suction hose 16 leading to a pump (not shown) and a second end 18 having a flexible suction tip 20 which is inserted into the mouth of the patient. The body 12 has a generally cylindrical, tubular shape having a switch 22 located near the first end 14. The position of the switch 22 is located on the opposite end 14 from the user's fingers 26. This makes it difficult for the user to switch suction device 10 on and off because the user must move his/her hand 24 in order to operate the switch 22.

Another problem with the known suction devices 10 is that the dentist or hygienist must rotate their hand 24 in uncomfortable positions in order to align the tip 28 of the suction tip 20 in the correct position within the patient's mouth. Consequently, during extended periods of use the operator's hand 24 can easily become fatigued, thus making the use of the prior art suction devices 10 more difficult for the operator.

The tip 28 of the suction tip 20 is typically a blunt end that may optionally include a grate 30 to prevent part of the patient's tongue and cheek from accidentally being sucked into the suction device 10. Because the tip 28 is blunt and the body 12 of the suction device 10 is cylindrical, it is often difficult for a single operator to maneuver the suction device 10 into a precise location within the patient's mouth.

Yet another problem with the known suction devices 10 is that the suction tip 20 is typically either a straight, rigid tube or a flexible tube. Often, the straight, rigid tube is too long and cumbersome to efficiently maneuver within the patient's mouth. While the flexible tubes maybe bent to form a desired shape, the operator must often support the suction tip 20 with his/her thumb or other finger 26 in order to prevent the suction tip 20 from bending under the stress during use. Consequently, extended periods of use often cause the operator's thumb/finger 26 to easily become fatigued, thus making the use of the known suction devices 10 more difficult and burdensome for the operator.

A further problem with the known suction devices 10 is that the high and low speed suction devices are separate units. As a result, the operator 24 must put down one suction device 10 in order to use the other suction device 10. This can become cumbersome and requires additional equipment and space.

Accordingly, what is needed is a suction device that is ergonomically shaped to reduce fatigue to the user's hand. The device should also allow the operator to operate the device, for example switch the device on and off, without having to move and reposition the user's hand. A need also exists for a suction tube that reduces the likelihood of part of the patient being accidentally sucked into the device, while also allowing a single operator to precisely place the tip of the suction tube in the intended location.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the following claims.

### SUMMARY

The present invention features a suction device for use during dental procedures and the like. According to one embodiment, the suction device includes a body having a first and a second end region. The first end region includes a first opening adapted to removably accept a suction tube. The second end region is in fluid communication with a pump and with the first end region.

The first and the second end region are disposed relative to each such that the body is contoured to a user's hand. According to one embodiment, the first end region is disposed at approximately a 45-degree angle relative to the second end region. Alternatively, the first and the second end region are hingedly connected such that the position of the first and the second end region may be changed. Optionally, the body further includes a gripping region adapted to engage with the user's hand.

The suction device also includes at least one switch disposed about the first end region of the body. The switch is adapted to switch the suction device between at least a hi and a low speed suction. In the preferred embodiment, the switch allows a user to turn the suction device on/off and switch between a hi speed and a low speed suction without removing the user's hand from the body of the suction device.

Optionally, the suction device also includes a tip support disposed proximate the first opening. The tip support is adapted to support at least a portion of the suction tube. In the preferred embodiment, the tip support is telescopically connected with the first end region such that a length of tip support is user-adjustable. Alternatively, the tip support is adjustably connected with the first end region such that a length of tip support is user-adjustable.

According to another embodiment, the present invention features a suction device including a body, a tip support, and at least one switch. The body is sized and shaped to ergonomically fit within a hand of a user and includes a first and a second end region. The first end region includes a first opening adapted to removably accept a suction tube. The second end region is in fluid communication with the first end region and with a pump. According to one embodiment, the first and the second end region are disposed at approximately a 45-degree angle with respect to each other. Alternatively, the first and the second end region are hingedly connected such that the position of the first and the second end region may be changed.

The tip support is disposed proximate the first opening and is adapted to support at least a portion of the suction tube. In the preferred embodiment, the tip support is telescopically connected with the first end region such that a length of tip support is user-adjustable. According to another embodiment, the tip support is adjustably connected with the first end region such that a length of tip support is user-adjustable.

The switch is preferably disposed about the body such that the user can operate the switch without removing the hand from the body of the suction device. In the preferred embodiment, the switch includes a first and at least a second switch.

According to yet another embodiment, the present invention features a suction tube for use with a suction device. The suction tube preferably includes a first and a second generally cylindrical region. The first generally cylindrical region includes a first opening adapted to be connected to a suction device. The second generally cylindrical region is disposed at an angle of approximately 65 degrees relative to the first generally cylindrical region and includes a second opening adapted to receive debris from a patient's mouth. A passageway is disposed through the first and the second generally cylindrical region and fluidly connects the first opening with the second opening.

In the preferred embodiment, the first generally cylindrical region is formed from a generally rigid material. According to one embodiment, the second generally cylindrical region is formed from a generally rigid material. Alternatively, the second generally cylindrical region may be formed from a generally flexible material.

The second opening preferably includes a generally oval shape. In the exemplary embodiment, the second opening faces a direction generally perpendicular to a longitudinal plane of the second generally cylindrical region.

### DESCRIPTION OF THE DRAWINGS

These and other features and advantages of the present invention will be better understood by reading the following detailed description, taken together with the drawings wherein:

FIG. 1 is a schematic view of a prior art suction device;

FIG. 2 is a schematic side view of a suction device, according to the present invention, along with a user's hand;

FIG. 3 is a side view of the suction device according to one embodiment of the present invention wherein the suction device includes both a high and a low speed suction device;

FIG. 4 is a side view of a suction device according to another embodiment of the present invention having an adjustable tip support;

FIG. 5 is a side view of a suction tip according to one embodiment of the present invention;

FIG. 6 is a side view of another embodiment of the suction tip shown in FIG. 5; and

FIG. 7 is a side view of yet another embodiment of the suction tip shown in FIG. 5.

### DESCRIPTION OF THE INVENTION

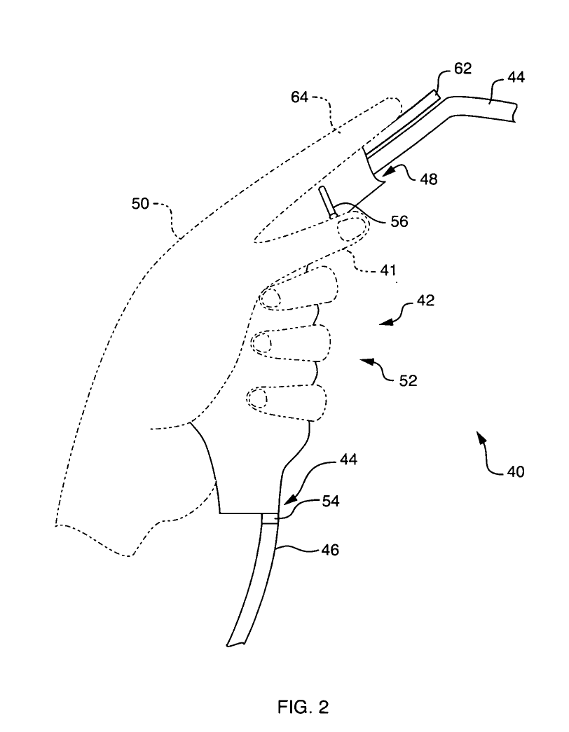

A suction device 40, FIG. 2, according to the present invention, includes a body section 42 and a removable disposable suction tip 44. The suction device 40 is typically used to remove debris from a patient's mouth during dental procedures and is connected to a pump (not shown) with a tube 46. The suction device 40, according to the present invention, is applicable to both high and low speed suction devices 40.

The body 42 of the suction device 40 is preferably made out of a lightweight, sterilizable, or autoclavable material such as, but not limited to, sterilizable plastics, composites, metal (such as stainless steel or aluminum) and the like. The body 42 includes a proximate or outlet end 44 which is connected to one or more hoses 46 leading to a pump(s) (not shown) and a distal or tip end 48 which is adapted to easily engage suction tips of different designs 44. The body 42 preferably has an ergonomic shape, which is adapted to fit the contours of the user/operator's hand or palm 50.

In the preferred embodiment, the proximate and distal ends 44, 48 are at approximately 45-degree angle relative to one another. This shape increases the operator's view within the patient's mouth since most of the suction device will be out of the operator's field of view. Alternatively, the body 42 may include be flexible (for example having a hinge) such that the angle between the proximate and distal ends 44, 48 may be adjusted depending upon the circumstances of the dental procedure.

The body 42 may also include a gripping section 52 designed to aid the user's hand 50 in grasping the suction device 40. The gripping surface 52 may include a high traction/friction concave surface such as a high traction polymer or the like, or may alternatively include a ribbed or contoured surface adapted to increase the traction with a user's hand.

The distal or outlet end 44 of the body 42 preferably includes one or more hose connections 54 used to connect the suction device 40 with the suction tube or line 46. The connections 54 may include any type of connection known to those skilled in the art, but preferably include a quick-connection such that the operator may quickly and easily remove the suction device 40 from the lines 46 in order to service or clean the suction device 40.

One or more switches 56, such as an on off switch and/or a high/low speed switch, are located proximate the distal or tip end 48 of the body 42. Having the switches 56 located proximate the distal end 48 allows an operator to control the suction device 40 (for example, to turn the suction device 40 on/off or switch the between the low and high speed) without having to move and reposition the operator's hand 50 with respect to the body 42. In the preferred embodiment, the switch 56 is located near the user's thumb 41.

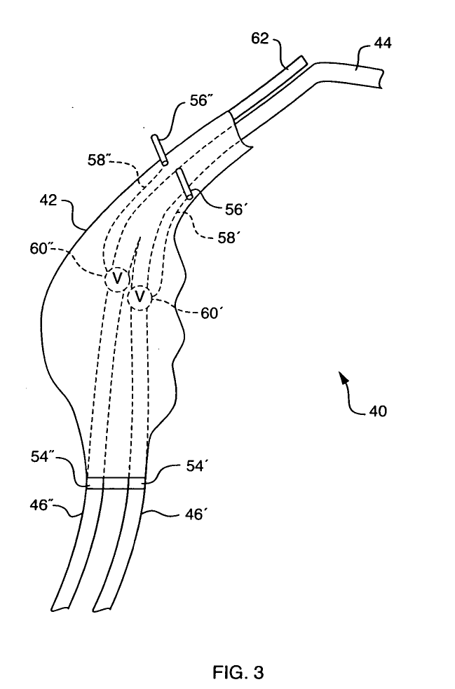

Referring specifically to FIG. 3, the suction device 40 may include an on/off switch 56′ and a high/low switch 56″. According to this embodiment, the suction device 40 operates as both a high and a low speed suction device 40 and includes a low speed suction line 46′ connected to a first connection 54′ and a high speed suction line 46′ connected to a second connection 54″. In use, the user may turn the suction device 40 on and off using the on/off switch 56′ as well as switch between the high and the low speed function using the high/low speed switch 56″.

The switches 56 may include any known switch/valve design such as buttons, tabs, sliders, and the like. The switches 56 may be an integral part of a valve, or alternatively may be a remotely located from the valve. According to one embodiment, linkage 58 is used to connect the valve 60 to the switch 56 when the valve 60 is located remotely from the switch 56.

The suction device 40 may also include a tip support 62, FIG. 2, preferably having a concave cross section that cradles one or more of the user's fingers (for example a user's index finger). The tip support 62 is adapted to support a user's finger 64 and gives the user more strength and comfort as the operator retracts the suction device 40 from the patient's mouth. The tip support 62 also supports a portion of the suction tip 44 and prevents the suction tip 44 from bending backwards when a flexible or deformable suction tip 44 is used. The tip support 62 prevents at least a portion of the suction tip 44 from bending or becoming deformed while in use and relieves the user from having to support the suction tip 44 with his/her finger 64. In a preferred embodiment, the tip support 62 is concave and approximately 3/8 inches wide by 1½ inches long.

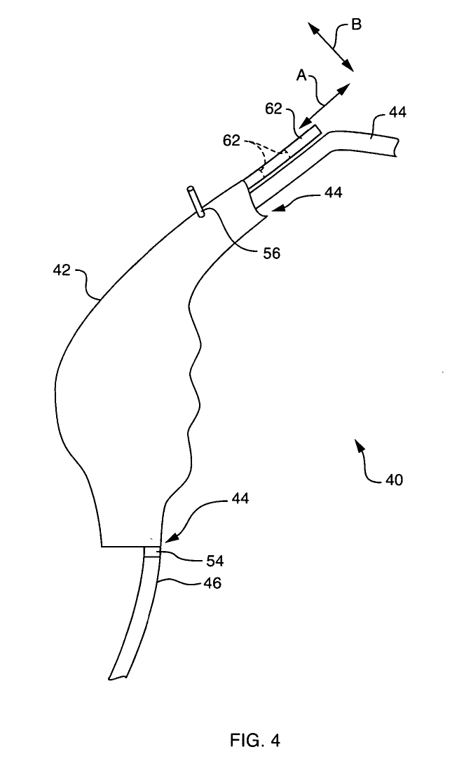

According to another embodiment, the tip support 62, FIG. 4, is adjustable such that the length of the tip support 62 may be adjusted in the direction indicated by arrow A, or right and left as indicated by arrow B. The tip support 62 is located proximate the distal or tip end 44, preferably above the suction tip 44. The tip support 62 may telescope or slide into the body 42 of the suction device 40 and/or adjust right or left according to the operator's preference.

According to this embodiment, the user may adjust the length of the tip support 62 or adjust it right or left according to the particular needs of the operator 50 and the dental procedure. For example, by extending the tip support 62 all the way out, the entire length of the suction tip 44 may be supported and maintain a straight or linear shape. In contrast, by retracting the top support 62, the suction tip 44 may form a hook shape, and the tip support 62 would support the portion of the suction tip 44 nearest the body 12.

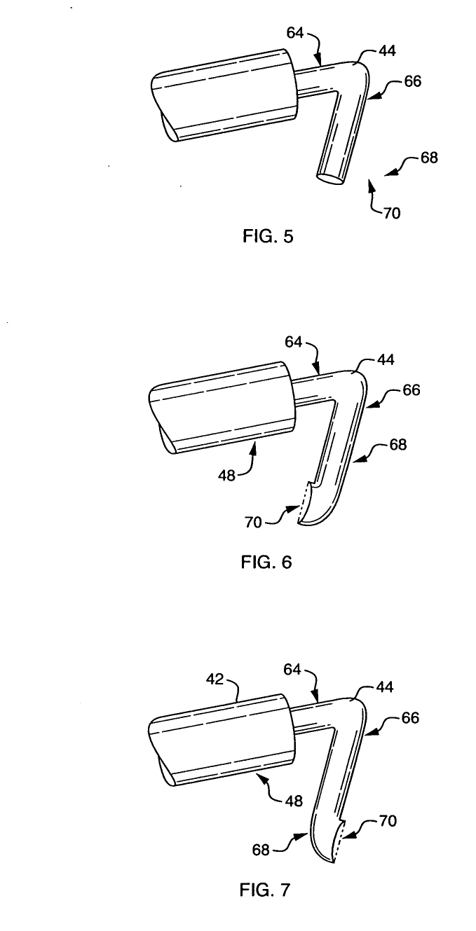

According to another embodiment, the suction tip 44, FIG. 5, preferably includes a first section 64 and a second section 66 disposed to form a rigid “V” shape. In the preferred embodiment, the first and second sections 64, 66 are disposed at approximately a 65° angle relative to one another. The first section 64 is adapted to easily connect and disconnect to the distal or tip end 48 of the body 42 of the suction device 40.

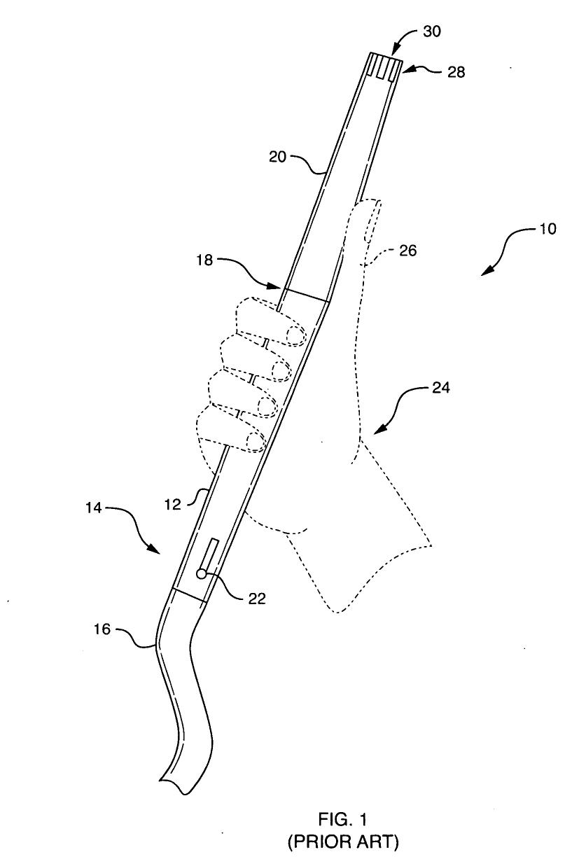

In a preferred embodiment, when the suction tip 44 is used with a high-speed suction device 40, the suction tip 44 is preferably made from a rigid material. According to another embodiment, the first section 64 leading in from a rigid material and the second section 66 is preferably made from a flexible or formable material. This embodiment is particular useful when using the suction tip 44 with conventional suction devices 10, FIG. 1.

The distal or suction end 68 of the second section 66 includes an opening 70 adapted to receive the debris from the patient's mouth. According to the preferred embodiment, the opening 70 includes an oval or fluted shape, for example, having a length of ¾″ and a width of approximately 3/8″. According to the preferred embodiment, the opening 70 of the suction tip 44 is disposed such that the opening 70 points generally towards the body 42 of the suction device 40 as shown in FIG. 6. Alternatively, the opening 70 is disposed such that it points away from the body 42 of the suction device 40 as is commonly referred to as a right and left disposable suction tip.

As mentioned above, the present invention is not intended to be limited to a system or method which must satisfy one or more of any stated or implied object or feature of the invention and should not be limited to the preferred, exemplary, or primary embodiment(s) described herein. The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as is suited to the particular use contemplated. All such modifications and variations are within the scope of the invention as determined by the claims when interpreted in accordance with breadth to which they are fairly, legally and equitably entitled.

1. A suction device comprising:
a body including:
a first end region having a first opening adapted to removably accept a suction tube; and
at least a second end region in fluid communication with a pump and with said first end region, said first and at least said second end region disposed relative to each such that said body is contoured to a user's hand; and
at least one switch disposed about said first end region of said body, said at least one switch adapted to switch said suction device between at least a hi and a low speed suction.

2. The suction device as claimed in claim 1 wherein said first end region is disposed at approximately a 45-degree angle relative to at least said second end region.

3. The suction device as claimed in claim 1 wherein said first and at least said second end region are hingedly connected such that the position of said first and at least said second end region may be changed.

4. The suction device as claimed in claim 2 wherein said body further includes a gripping region adapted to engage with said user's hand.

5. The suction device as claimed in claim 1 wherein said first end region further includes a tip support disposed proximate said first opening, said tip support adapted to support at least a portion of said suction tube.

6. The suction device as claimed in claim 5 wherein said tip support is telescopically connected with said first end region such that a length of tip support is user-adjustable.

7. The suction device as claimed in claim 5 wherein said tip support is adjustably connected with said first end region such that a length of tip support is user-adjustable.

8. The suction device as claimed in claim 1 wherein said at least one switch allows a user to turn said suction device on/off and switch between a hi speed and a low speed suction without removing said user's hand from said body of said suction device.

9. A suction device comprising:
a body sized and shaped to ergonomically fit within a hand of a user, said body including a first end region having a first opening adapted to removably accept a suction tube and at least a second end region in fluid communication with said first end region and with a pump;
a tip support disposed proximate said first opening, said tip support adapted to support at least a portion of said suction tube; and
at least one switch disposed about said body such that said user can operate said switch without removing said hand from said body of said suction device.

10. The suction device as claimed in claim 9 wherein said first and at least said second end region are disposed at approximately a 45-degree angle with respect to each other.

11. The suction device as claimed in claim 9 wherein said first and at least said second end region are hingedly connected such that the position of said first and at least said second end region may be changed.

12. The suction device as claimed in claim 9 wherein said switch includes a first and at least a second switch.

13. The suction device as claimed in claim 9 wherein said tip support is telescopically connected with said first end region such that a length of tip support is user-adjustable.

14. The suction device as claimed in claim 9 wherein said tip support is adjustably connected with said first end region such that a length of tip support is user-adjustable.

15. A suction tube comprising:
a first generally cylindrical region including a first opening adapted to be connected to a suction device;
a second generally cylindrical region disposed at an angle of approximately 65 degrees relative to said first generally cylindrical region, said second generally cylindrical region including a second opening adapted to receive debris from a patient's mouth; and
a passageway disposed through said first and said second generally cylindrical region and fluidly connecting said first opening with said second opening.

16. The suction tube as claimed in claim 15 wherein said first generally cylindrical region is formed from a generally rigid material.

17. The suction tube as claimed in claim 16 wherein said second generally cylindrical region is formed from a generally rigid material.

18. The suction tube as claimed in claim 16 wherein said second generally cylindrical region is formed from a generally flexible material.

19. The suction tube as claimed in claim 15 wherein said second opening includes a generally oval shape.

20. The suction device as claimed in claim 15 wherein said second opening faces a direction generally perpendicular to a longitudinal plane of said second generally cylindrical region.
